(19) United States
(12) Patent Application Publication
(10) Pub. No.: US 2025/0292566 A1
(43) Pub. Date: Sep. 18, 2025

(54) PREPROCESSING METHODS AND APPARATUSES FOR REMOTE SENSING IMAGES, AND REPRESENTATION DETERMINING METHODS AND APPARATUSES FOR REMOTE SENSING IMAGES

(71) Applicant: Alipay (Hangzhou) Information Technology Co., Ltd., Hangzhou (CN)

(72) Inventors: Xin Guo, Hangzhou (CN); Jiangwei Lao, Hangzhou (CN); Jian Wang, Hangzhou (CN); Jingdong Chen, Hangzhou (CN); Ming Yang, Hangzhou (CN)

(73) Assignee: Alipay (Hangzhou) Information Technology Co., Ltd., Hangzhou (CN)

(21) Appl. No.: 19/079,694

(22) Filed: Mar. 14, 2025

(30) Foreign Application Priority Data
Mar. 15, 2024 (CN) 202410303395.6

(51) Int. Cl. G06V 20/10; G06V 10/26; G06V 10/40; G06V 10/762

(52) U.S. Cl. CPC G06V 20/10; G06V 10/26; G06V 10/40; G06V 10/762

(57) ABSTRACT

Implementations of this specification provide methods and apparatuses for remote sensing images. One example method comprises: dividing a global remote sensing image into sub-image regions in a predetermined manner, for each sub-image region of the sub-image regions: (1) determining image point features of image points in the sub-image region based on a feature extraction model, (2) identifying image points in the sub-image region based on the image point features, and (3) determining a cluster center for the identified image points, and adjusting a remote sensing model based on cluster centers determined for each of the sub-image regions.

### CROSS-REFERENCE TO RELATED APPLICATIONS

This application claims priority to Chinese Patent Application No. 202410303395.6, filed on Mar. 15, 2024, which is hereby incorporated by reference in its entirety.

### TECHNICAL FIELD

One or more embodiments of this specification relate to the field of remote sensing image processing technologies, and in particular, to preprocessing methods and apparatuses for remote sensing images, and representation determining methods and apparatuses for remote sensing images.

### BACKGROUND

With widespread applications of deep learning in computer vision, deep learning has also found many applications in the field of remote sensing. In the field of remote sensing, a deep learning technology can be used to interpret remote sensing images, thereby implementing detection of target objects on the earth. Global remote sensing images, also referred to as remote sensing base maps, are often large-scale and high-definition images covering a large area, and can provide a lot of information support in the application process of remote sensing interpretation. In the data processing process, privacy data in the related images needs to be protected. However, when data modeling is performed on the global remote sensing base map, there may be problems that the hardware conditions of a computing device cannot support a huge quantity of pixels.

Therefore, an improved solution is needed to more effectively process global remote sensing images, thereby providing more accurate and effective data information for a remote sensing interpretation process.

### SUMMARY

One or more embodiments of this specification describe preprocessing methods and apparatuses for remote sensing images, and representation determining methods and apparatuses for remote sensing images, to more effectively process global remote sensing images, thereby providing more accurate and effective data information for a remote sensing interpretation process. Specific technical solutions are as follows.

According to a first aspect, one or more embodiments provide a preprocessing method for remote sensing images. The method includes: dividing a global remote sensing image-image region, image point features of a plurality of image points in the sub-image region by a feature extraction model; clustering, for any sub-image region, image points in the sub-image region based on image point features in the sub-image region, and determining a cluster center to which the image points in the sub-image region belong; and using cluster centers corresponding to image points in the plurality of sub-image regions as representations of the corresponding sub-image regions to adjust a remote sensing model.

In some implementations, the step of dividing a global remote sensing image into a plurality of sub-image regions based on a predetermined method includes: dividing the global remote sensing image based on a predetermined remote sensing tile-level size; or dividing the global remote sensing image based on geographical regions included in the global remote sensing image.

In some implementations, the step of determining image point features of a plurality of image points in the sub-image region by a feature extraction model includes: obtaining prior knowledge of the sub-image region; and determining the image point features of the plurality of image points in the sub-image region by the feature extraction model based on the prior knowledge.

In some implementations, the step of determining the image point features of the plurality of image points in the sub-image region by the feature extraction model based on the prior knowledge includes: dividing the sub-image region into a plurality of patches; and for any patch, inputting the prior knowledge and the patch into the feature extraction model to obtain image point features of a plurality of image points in the patch.

In some implementations, a size of the image point includes a predetermined pixel-level size.

According to a second aspect, one or more embodiments provide a representation determining method for remote sensing images. The method includes: obtaining a first remote sensing image to be processed and first position information of the first remote sensing image; determining, based on the first position information, a first sub-image region having position information that matches the first position information from a plurality of sub-image regions included in a global remote sensing image; determining a target image point corresponding to the first remote sensing image from image points included in the first sub-image region; determining, from pre-obtained correspondences between the image points and cluster centers, a cluster center to which the target image point belongs, where the image points and the corresponding cluster centers are determined based on the method according to the first aspect; and determining a representation of the first remote sensing image based on the cluster center to which the target image point belongs.

In some implementations, the step of determining a target image point corresponding to the first remote sensing image from image points included in the first sub-image region includes: determining the target image point corresponding to the first remote sensing image in the first sub-image region based on the position information of the first sub-image region and positions of a plurality of image points in the first sub-image region.

In some implementations, the step of determining a cluster center to which the target image point belongs includes: determining the cluster center to which the target image point belongs from the pre-obtained correspondences between the image points included in the first sub-image region and the cluster centers.

In some implementations, the step of determining a representation of the first remote sensing image includes: performing feature fusion on the cluster center to which the target image point belongs and the first remote sensing image to obtain the representation of the first remote sensing image.

In some implementations, the step of performing feature fusion on the cluster center to which the target image point belongs and the first remote sensing image includes: when there are a plurality of target image points, concatenating cluster centers to which the plurality of target image points belong, to obtain a concatenated representation; and performing feature fusion on the concatenated representation and image features of the first remote sensing image.

According to a third aspect, one or more embodiments provide a preprocessing apparatus for remote sensing images. The apparatus includes: a region division module, configured to divide a global remote sensing image into a plurality of sub-image regions based on a predetermined method; a feature extraction module, configured to determine, for any sub-image region, image point features of a plurality of image points in the sub-image region by a feature extraction model; an image point clustering module, configured to cluster, for any sub-image region, image points in the sub-image region based on image point features in the sub-image region, and determine a cluster center to which the image points in the sub-image region belong; and a representation determining module, configured to use cluster centers corresponding to image points in the plurality of sub-image regions as representations of the corresponding sub-image regions to adjust a remote sensing model.

According to a fourth aspect, one or more embodiments provide a representation determining apparatus for remote sensing images. The apparatus includes: an image acquisition module, configured to obtain a first remote sensing image to be processed and first position information of the first remote sensing image; a region matching module, configured to determine, based on the first position information, a first sub-image region having position information that matches the first position information from a plurality of sub-image regions included in a global remote sensing image; an image point determining module, configured to determine a target image point corresponding to the first remote sensing image from image points included in the first sub-image region; a cluster determining module, configured to determine, from pre-obtained correspondences between the image points and cluster centers, a cluster center to which the target image point belongs, where the image points and the corresponding cluster centers are determined based on the method according to the first aspect; and a representation determining module, configured to determine a representation of the first remote sensing image based on the cluster center to which the target image point belongs.

According to a fifth aspect, some embodiments provide a computer-readable storage medium. The computer-readable storage medium stores a computer program, and when the computer program is executed in a computer, the computer is enabled to perform the method according to either of the first aspect and the second aspect.

According to a sixth aspect, some embodiments provide a computing device, including a storage and a processor. The storage stores executable code, and when executing the executable code, the processor implements the method according to either of the first aspect and the second aspect.

In the methods and apparatuses provided in some embodiments of this specification, the global remote sensing image is divided into the plurality of sub-image regions, and the image points in the sub-image regions are clustered to obtain the correspondences between the image points and the cluster centers. The cluster centers corresponding to the image points in the sub-image regions are used as representations of the sub-image regions and thus used to adjust the remote sensing model, thereby implementing spatial context modeling on an ultra-large spatial scale. After the correspondence between the image points in the sub-image region and the cluster centers is obtained, the cluster centers are used as a representation of the global remote sensing image. It reduces the modeling of pixels of the global remote sensing image, can expand the modeling scale to a larger geographic area, and is free from hardware limitations of computing devices, thereby achieving effective processing of the global remote sensing image, and can provide more accurate and effective data information for a remote sensing interpretation process.

### BRIEF DESCRIPTION OF DRAWINGS

To describe the technical solutions in some embodiments of this application more clearly, the following briefly describes the accompanying drawings needed for describing the embodiments. Clearly, the accompanying drawings in the following description merely illustrate some embodiments of this application, and a person of ordinary skill in the art can derive other drawings from these accompanying drawings without creative efforts.

FIG. 1 is a schematic diagram illustrating an implementation scenario of some embodiments, according to this specification;

FIG. 2 is a schematic flowchart illustrating a preprocessing method for remote sensing images, according to some embodiments;

FIG. 3 is a schematic flowchart illustrating a representation determining method for remote sensing images, according to some embodiments;

FIG. 4 is a schematic block diagram illustrating a preprocessing apparatus for remote sensing images, according to some embodiments; and

FIG. 5 is a schematic block diagram illustrating a representation determining apparatus for remote sensing images, according to some embodiments.

### DESCRIPTION OF EMBODIMENTS

The solutions provided in this specification are described below with reference to the accompanying drawings.

Remote sensing images, also known as remote sensing imagery, are images obtained using a remote sensing technology, including high-resolution red, green, and blue (RGB) imagery, medium-resolution multispectral imagery, radar imagery, etc. The remote sensing images are imagery of the surface of the earth obtained at a long distance through remote sensing platforms such as satellites, aircraft, drones, and radars. The remote sensing images can reflect images of various objects on the surface of the earth.

Remote sensing interpretation is a process of performing classification, identification, and information extraction on ground objects, such as buildings and crops, based on remote sensing images. The remote sensing interpretation can be implemented through both manual visual inspection and algorithm recognition. The embodiments of this specification mainly focus on using algorithm recognition to complete the interpretation.

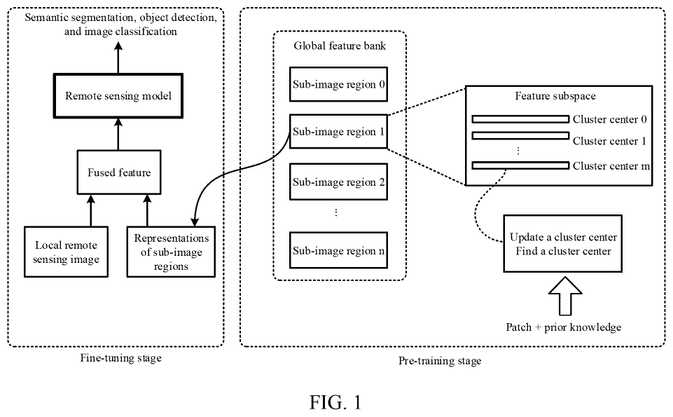

The remote sensing interpretation can be implemented through a remote sensing model, and the remote sensing model is a network model obtained through training using a machine learning algorithm such as deep learning. The remote sensing interpretation process based on the remote sensing model includes a pre-training stage and a fine-tuning stage, as shown in FIG. 1.

FIG. 1 is a schematic diagram illustrating an implementation scenario of some embodiments, according to this specification. The implementation scenario includes a pre-training stage and a fine-tuning stage. A global remote sensing image is divided into a plurality of sub-image regions: sub-image region 0 to sub-image region n. Each sub-image region corresponds to a plurality of cluster centers. For example, sub-image region 1 includes the following cluster centers: cluster center 0 to cluster center m. In the pre-training stage, the global remote sensing image can be divided into the plurality of sub-image regions; then, the cluster centers of each sub-image region can be determined for image points in the sub-image region, and these cluster centers are a representation of the sub-image region. The plurality of sub-image regions included in the global remote sensing image are included in a global feature bank, and a plurality of cluster centers included in each sub-image region are included in a global feature subspace. In the fine-tuning stage, feature fusion can be performed on the representation of the sub-image region and features of a local remote sensing image to obtain a fused feature, and then, the fused feature and the remote sensing model can be used to interpret the remote sensing image and perform tasks such as semantic segmentation, object detection, and image classification.

The global remote sensing image is pre-acquired large-scale remote sensing image. In the pre-training stage, a representation is obtained from the global remote sensing image, and the representation can be used in the fine-tuning stage. In the fine-tuning stage, for any input remote sensing image to be interpreted, the remote sensing image can be interpreted based on the representation of the global remote sensing image.

Global remote sensing images can also be referred to as remote sensing base maps, and usually have a large coverage area and a huge quantity of pixels. For example, a global remote sensing image may be a global-level remote sensing image or a nation-level remote sensing image. When the global remote sensing image is processed, high hardware requirements are placed on a computing device. Current hardware conditions cannot support direct processing of the global remote sensing image. In some implementations, the global remote sensing image can be directly divided into small patches for feature extraction, and feature extraction results can be concatenated to obtain a representation of the global remote sensing image. Alternatively, a range and a pixel quantity of the global remote sensing image are limited to small values, so that feature extraction is directly performed on the global remote sensing image, which places high requirements on hardware conditions of the computing device.

In the pre-training stage, in order to avoid losing spatial context information of the patches, improve recognition accuracy, and be free from hardware limitations of computing devices, the embodiments of this specification provide a preprocessing method for remote sensing images. The method includes the following steps: Step S210: Divide a global remote sensing image into a plurality of sub-image regions based on a predetermined method. Step S220: Determine, for any sub-image region, image point features of a plurality of image points in the sub-image region by a feature extraction model. Step S230: Cluster, for any sub-image region, image points in the sub-image region based on image point features in the sub-image region, and determine a cluster center to which the image points in the sub-image region belong. Step S240: Use cluster centers corresponding to image points in the plurality of sub-image regions as representations of the corresponding sub-image regions to adjust a remote sensing model.

In the embodiments, the global remote sensing image is divided into the plurality of sub-image regions, and the image points in the sub-image regions are clustered to obtain the cluster centers corresponding to the image points as the representations of the sub-image regions. This method is free from hardware limitations of computer devices, and enables spatial context modeling on an ultra-large spatial scale. Clustering the image points takes the spatial context information into full account. The embodiment uses the representations of the sub-image regions in the fine-tuning stage, reducing the reliance on pixel modeling.

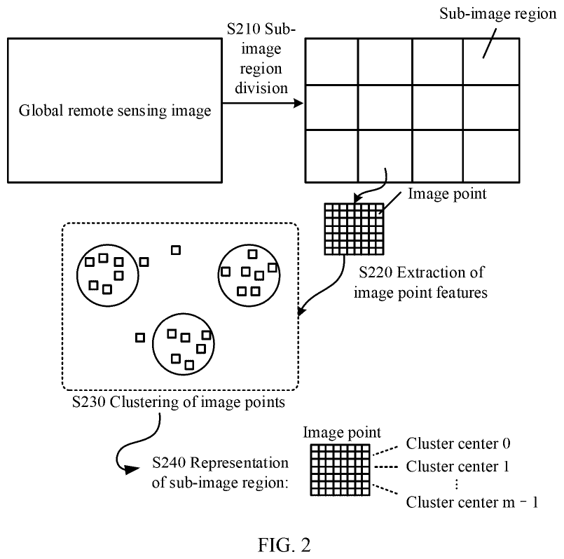

The following describes the embodiments in detail with reference to FIG. 2. FIG. 2 is a schematic flowchart illustrating a preprocessing method for remote sensing images, according to some embodiments. The method is performed by a computing device. The computing device can be implemented by any apparatus, device, platform, device cluster, etc. having computing and processing capabilities. The method includes the following steps.

Step S210: Divide a global remote sensing image into a plurality of sub-image regions based on a predetermined method.

A processing process for any global remote sensing image is described here. At different moments, a plurality of global remote sensing images can be obtained, and the processing processes of the plurality of global remote sensing images are the same. As mentioned above, global remote sensing images can be remote sensing images of ultra-large spatial scales, such as global-level remote sensing images, or national-level remote sensing images, or provincial-level remote sensing images. The scale of the sub-image region obtained through division is the scale for spatial context modeling of the global remote sensing image.

During division, the global remote sensing image can be divided based on geographical regions included in the global remote sensing image. The geographical regions include divisions based on provinces, cities, districts, counties, Northeast China, North China, South China, and other regions. For example, the global remote sensing image can be divided based on range boundaries such as counties or cities.

Alternatively, the global remote sensing image can be divided based on a predetermined remote sensing tile-level size. For example, the global remote sensing image can be divided based on a tile size of 8, 9, or 10, or can be divided based on other tile sizes. The predetermined remote sensing tile-level size can be a size comparable to a county or a city.

The sub-image region obtained through division can be a predetermined large-scale region, which is a size that can be directly processed in the hardware conditions of the current computing device, and the size can be predetermined. The embodiments do not limit the shape of the sub-image region obtained through division.

FIG. 2 illustrates an example of dividing a rectangular global remote sensing image into a plurality of rectangular sub-image regions. The plurality of sub-image regions obtained through division can be of any shape, and the shapes of the sub-image regions are not limited here.

Step S220: Determine, for any sub-image region region0, image point features of a plurality of image points in the sub-image region region0 by a feature extraction model. The above-mentioned operations are performed on the sub-image regions in the global remote sensing image.

The image point is a pixel region in the sub-image region region0, and a shape of the image point can include various shapes, such as a rectangle, a square, or a triangle. The size of the image point can be as small as possible, and can be a predetermined pixel-level size. For example, the image point can be a region of 128, 256, 512, or 1024 pixels, or even a region of a few pixels, or a region of a larger quantity of pixels. It can be considered that in the face of the very large quantity of pixels in global remote sensing images, pixel values within the range of 10,000 times of 1 pixel can be considered to be at a pixel level.

The sub-image region region0 is divided into a large quantity of image points, and a quantity of pixels of an image point can be set based on experience. The quantity of pixels in the image point is also consistent with an image region corresponding to features output by the feature extraction model. As shown in FIG. 2, in this step, using any sub-image region as an example, the sub-image region is divided into a large quantity of image points.

The feature extraction model can be a trained model. The feature extraction model belongs to a backbone network of the entire processing process, and can be implemented through a transformer network. The transformer network is a common module for processing sequence data in deep learning, and includes a multi-head attention layer, a layer normalization (LayerNorm) layer, and a fully-connected feed-forward network (FFN). When image point features are specifically determined, the sub-image region region0 can be input into a feature extraction network, and features of a plurality of pixel regions can be output through the feature extraction network. The pixel region is an image point, and the feature is an image point feature.

When a quantity of pixels in the sub-image region region0 is relatively large, the sub-image region region0 can be divided into a plurality of patches, and each patch is input into the feature extraction network to obtain image point features of a plurality of image points. The sub-image region region0 includes a plurality of patches, each patch includes a plurality of image points, and a set of image points in all the patches is all image points in the sub-image region region0.

After processing of the above-mentioned steps, image point features respectively corresponding to the plurality of sub-image regions can be determined, and each sub-image region includes image point features of a plurality of image points.

Step S230: Cluster, for any sub-image region region0, image points in the sub-image region region0 based on image point features in the sub-image region, and determine a cluster center to which the image points in the sub-image region region0 belong. The above-mentioned operations are performed on the sub-image regions in the global remote sensing image. Different sub-image regions are clustered independently.

This step can be performed using a plurality of existing clustering algorithms. A clustering algorithm is an algorithm that assigns a plurality of feature vectors to different categories of algorithms based on a distance metric function, usually in an unsupervised way. The clustering algorithm includes but is not limited to a K-means clustering algorithm. During clustering, the cluster center of the sub-image region region0 can be initialized, and the cluster center can be iteratively updated based on image point features of the sub-image region region0. In any iteration, a vector distance between each of the image point features of the image points included in the sub-image region region0 and each cluster center is determined, and the cluster center to which the image points belong is determined from a plurality of cluster centers based on the vector distance. For any cluster center, a representation vector of the cluster center is updated based on image point features of image points belonging to the cluster center.

During clustering, a representation vector gᵢ of m cluster centers can be randomly initialized. During iteration, for the cluster center gᵢ, an optimal representation vector can be determined from a plurality of image point features, and the corresponding cluster center gᵢ can be updated using the optimal representation vector. Specifically, a Sinkhorn-Knopp algorithm can be used to determine the optimal representation vector, and an exponential moving average (EMA) algorithm can be used to update a corresponding cluster center gᵢ based on the optimal representation vector. The Sinkhorn-Knopp algorithm is based on a uniform distribution assumption. When considering a vector distance between the image point features and the cluster center, a constrained optimal representation search method is used to make all image points relatively evenly distributed near the cluster center as much as possible to prevent the model from collapsing during training. The EMA algorithm updates the cluster center based on the following formula: cluster center=α*original cluster center+(1−α) optimal representation vector. By setting a suitable a value, an updating process of the cluster center can become smoother.

Through the clustering operation of step S230, in the embodiments, the image points in the sub-image region can be enabled to correspond to m cluster centers respectively, and the representation vectors of the cluster centers can be used as the representations of the corresponding image points. FIG. 2 is a schematic diagram of clustering image points. In the figure, small squares represent image points, and circles represent clusters corresponding to cluster centers.

The image points are clustered within the sub-image region. The cluster center takes into account features of a plurality of similar image points. Therefore, using the cluster center as the representation of the sub-image region takes into account spatial context information of the image points, and the representation is more accurate.

Step S240: Use cluster centers corresponding to image points in the plurality of sub-image regions as representations of the corresponding sub-image regions to adjust a remote sensing model. In practice, the correspondence between the image points in each sub-image region and cluster centers can be stored for use in the fine-tuning stage of remote sensing interpretation and in executing downstream tasks. For example, the representation of the sub-image region region0 includes: a correspondence between a plurality of image points and a plurality of cluster centers, and the plurality of cluster centers include cluster center 0, cluster center 1, . . . , cluster center m-1, etc.

In some other embodiments of the this specification, in order to determine a more accurate cluster center representation vector, the embodiments can further introduce prior knowledge of the sub-image region. When determining the image point features of the plurality of image points in the sub-image region region0 by the feature extraction model, the prior knowledge of the sub-image region region0 can be obtained. Next, the image point features of the plurality of image points in the sub-image region region0 is determined by the feature extraction model based on the prior knowledge.

The prior knowledge of the sub-image region can be text information, etc. The prior knowledge can characterize features of the sub-image region. For example, the sub-image region is a county, and the county is a main peanut producing region. When the image point features are determined, the word “main peanut producing region” can be extracted through a text feature extraction model to obtain an embedding vector of the word, and the embedding vector and the sub-image region region0 can be input into the feature extraction model together.

When the sub-image region region0 is divided into a plurality of patches for processing, for any patch, the prior knowledge and the patch can be input into the feature extraction model to obtain image point features of a plurality of image points in the patch.

In some implementations, time information related to the global remote sensing image can be further input into the feature extraction model together with the prior knowledge and the patch to determine the image point features of the plurality of image points in the patch. Combining the prior knowledge and the time information with the patch can make the image point features more accurate.

The above-mentioned embodiments belong to the pre-training stage of the remote sensing model. The embodiments have good flexibility and scalability, and can freely select the scale of spatial context modeling to achieve multi-scale spatial context modeling. Moreover, the representation of the global remote sensing image or the representation of the sub-image region is a set of vectors. Using this representation to fine-tune the remote sensing model is no longer subject to hardware limitations of computing devices on pixels and reduces the modeling of raw pixels, thereby implementing context modeling on an ultra-large spatial scale. For example, the modeling scale can be expanded to the county level, the city level, or even the national level.

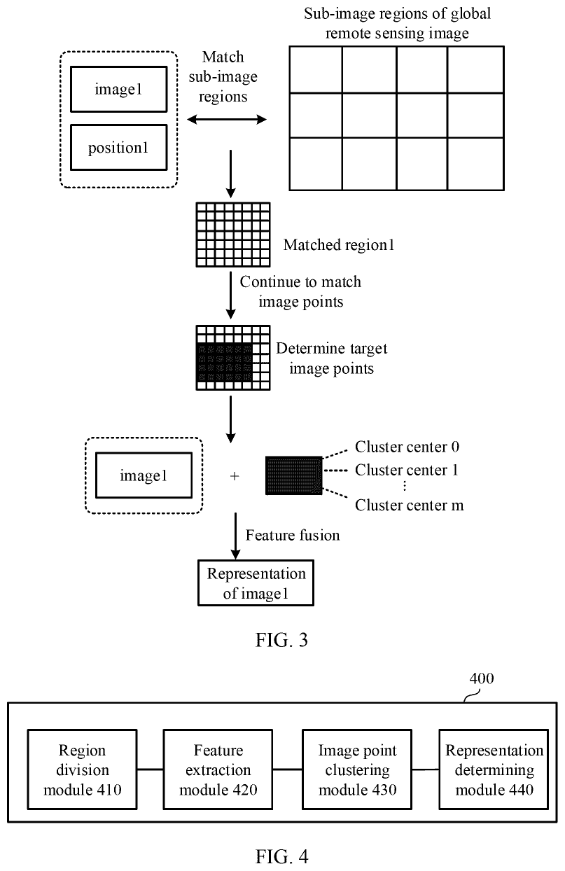

In the downstream fine-tuning stage, the embodiments can use the representation of the global remote sensing image obtained in the embodiments of FIG. 2 to perform fine-tuning. The following makes descriptions in detail with reference to the embodiments of FIG. 3.

FIG. 3 is a schematic flowchart illustrating a representation determining method for remote sensing images, according to some embodiments. The method is performed by a computing device. The method includes the following steps.

Step S310: Obtain a first remote sensing image image1 to be processed and first position information position1 of the first remote sensing image. The first remote sensing image can be any remote sensing image, and can be, but is not limited to, a remote sensing image of a patch size, or can be a remote sensing image of any size. The first position information can be longitude and latitude information of the first remote sensing image.

Step S320: Determine, based on the first position information position1, a first sub-image region region1 having position information that matches the first position information from a plurality of sub-image regions included in a global remote sensing image. During matching, position information of each sub-image region in the global remote sensing image can be matched with the first position information position1, and the sub-image region in an overlapping portion between the regions of the position information and the first position information position1 can be determined as the first sub-image region region1. There can be one or more matching first sub-image regions region1. For a clearer description, a first sub-image region region1 is used as an example for description below.

Step S330: Determine a target image point corresponding to the first remote sensing image image1 from image points included in the first sub-image region region1.

In order to more accurately determine an image region that matches the first remote sensing image image1 in terms of position from the first sub-image regions region1, the first remote sensing image image1 can continue to be matched with the image points. For example, the target image point corresponding to the first remote sensing image region1 in the first sub-image region is determined based on the first position information position1 and positions of a plurality of image points in the first sub-image region region1.

When the target image point is determined, a similarity between the images can also be used to perform pixel matching between the first sub-image region region1 and the first remote sensing image image1 to obtain a matching region, and an image point in the matching region is used as a target image point. For example, in FIG. 3, the target image points obtained are represented by the black region.

Step S340: Determine the cluster center to which the target image point belongs from the pre-obtained correspondence between the image points and the cluster centers. The image points and the corresponding cluster centers are determined based on the method embodiments shown in FIG. 2. Details are omitted here for simplicity.

When the correspondences between the image points and the cluster centers are stored independently based on different sub-image regions, the cluster center to which the target image point belongs can be determined from the correspondences between the image points included in the first sub-image region region1 and the cluster centers, thereby improving search efficiency.

Step S350: Determine a representation of the first remote sensing image image1 based on the cluster center to which the target image point belongs. The image region formed by the target image point and the first remote sensing image image1 are remote sensing images of the same region a, but are acquired at different times and using different acquisition devices. The first remote sensing image image1 is an updated remote sensing image of region a, and features of the remote sensing image can be used to fine-tune the representation of region a to make the obtained representation more accurate.

In a specific application, feature fusion can be performed on the cluster center to which the target image point belongs and the first remote sensing image image1, to obtain the representation of the first remote sensing image image1. When feature fusion is performed, the image features of the first remote sensing image image1 can be features obtained after the first remote sensing image image1 is input into the feature extraction model.

When there are a plurality of target image points, the cluster centers to which the plurality of target image points belong can be concatenated first, to obtain a concatenated representation. Then, feature fusion is performed on the concatenated representation and the image features of the first remote sensing image image1.

When the image features of the first remote sensing image image1 are determined, related knowledge information and the first remote sensing image image1 can be input into the feature extraction model together.

In step S310, the obtained first remote sensing image image1 can include a high-definition remote sensing image and a medium-resolution remote sensing image. When the feature extraction model is used to extract features, the high-definition remote sensing image, the medium-resolution remote sensing image, and the related knowledge information can be concatenated and then input into the feature extraction model to expand feature extraction of the first remote sensing image image1 to a plurality of modalities.

A spatial context modeling process of an ultra-large spatial scale in the pre-training stage in FIG. 1 can be referred to as Global-Local Bank (GL Bank). Attention fusion and residual connection can be performed on the first remote sensing image image1 and the features output by the GL Bank, that is, the cluster centers to which the target image points belong. For example, for attention fusion, references can be made to the formula: Attention(x_{image1}, Cat (x_{image1}, G), Cat(x_{image1}, G)). Here, x_{image1} is an image feature of the first remote sensing image image1, G is a cluster center vector, and Cat is a fusion function.

The embodiments of FIG. 3 are a process of fine-tuning using a remote sensing image. After obtaining the representation of the first remote sensing image, a specific recognition task can be performed based on the representation.

The above is a processing process of the pre-training stage and the fine-tuning stage of the remote sensing model. In the pre-training stage of the remote sensing model, a comparative learning process of the global remote sensing image can also be included. Contrastive learning is a branch of self-supervised algorithms in the field of computer vision, and constructs different views of the same image to perform feature attraction learning and perform feature repulsion learning on different images, thereby establishing pre-trained image features with strong semantic information for optimizing the accuracy of the downstream fine-tuning stage and task recognition.

In this specification, “first” in the first remote sensing image, the first position information, etc. and “second” (if any) in the text are used only for ease of distinction and description, and do not have any limited meaning.

Some specific embodiments of this specification have been described above, and other embodiments fall within the scope of the appended claims. In some cases, actions or steps described in the claims can be performed in a sequence different from that in the embodiments and desired results can still be achieved. In addition, processes described in the accompanying drawings do not necessarily need a specific order or a sequential order shown to achieve the desired results. In some implementations, multitasking and parallel processing are also feasible or may be advantageous.

FIG. 4 is a schematic block diagram illustrating a preprocessing apparatus for remote sensing images, according to some embodiments. The apparatus 400 is deployed in a computing device. The computing device can be implemented by any apparatus, device, platform, device cluster, etc. having computing and processing capabilities. The apparatus embodiments correspond to the method embodiments shown in FIG. 2. The apparatus 400 includes: a region division module 410, configured to divide a global remote sensing image into a plurality of sub-image regions based on a predetermined method; a feature extraction module 420, configured to determine, for any sub-image region, image point features of a plurality of image points in the sub-image region by a feature extraction model; an image point clustering module 430, configured to cluster, for any sub-image region, image points in the sub-image region based on image point features in the sub-image region, and determine a cluster center to which the image points in the sub-image region belong; and a representation determining module 440, configured to use cluster centers corresponding to image points in the plurality of sub-image regions as representations of the corresponding sub-image regions to adjust a remote sensing model.

In some implementations, the specific configuration of the region division module 410 includes dividing the global remote sensing image based on a predetermined remote sensing tile-level size; or the specific configuration of the region division module 410 includes dividing the global remote sensing image based on geographical regions included in the global remote sensing image.

In some implementations, the specific configuration of the feature extraction module 420 includes: an acquisition submodule (not shown in the figure), configured to obtain prior knowledge of the sub-image region; and an extraction submodule (not shown in the figure), configured to determine the image point features of the plurality of image points in the sub-image region by the feature extraction model based on the prior knowledge.

In some implementations, the specific configuration of the extraction submodule includes: dividing the sub-image region into a plurality of patches; and for any patch, inputting the prior knowledge and the patch into the feature extraction model to obtain image point features of a plurality of image points in the patch.

In some implementations, a size of the image point includes a predetermined pixel-level size.

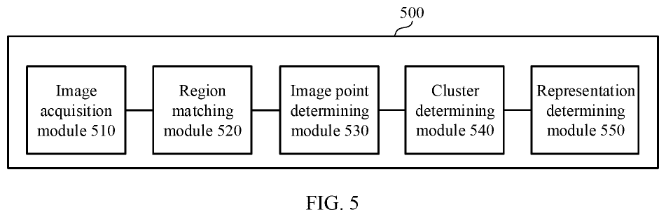

FIG. 5 is a schematic block diagram illustrating a representation determining apparatus for remote sensing images, according to some embodiments. The apparatus 500 is deployed in a computing device. The computing device can be implemented by any apparatus, device, platform, device cluster, etc. having computing and processing capabilities. The apparatus embodiments correspond to the method embodiments shown in FIG. 3. The apparatus 500 includes: an image acquisition module 510, configured to obtain a first remote sensing image to be processed and first position information of the first remote sensing image; a region matching module 520, configured to determine, based on the first position information, a first sub-image region having position information that matches the first position information from a plurality of sub-image regions included in a global remote sensing image; an image point determining module 530, configured to determine a target image point corresponding to the first remote sensing image from image points included in the first sub-image region; a cluster determining module 540, configured to determine, from pre-obtained correspondences between the image points and cluster centers, a cluster center to which the target image point belongs, where the image points and the corresponding cluster centers are determined based on the method in the embodiments shown in FIG. 2; and a representation determining module 550, configured to determine a representation of the first remote sensing image based on the cluster center to which the target image point belongs.

In some implementations, the specific configuration of the cluster determining module 540 includes: determining the target image point corresponding to the first remote sensing image in the first sub-image region based on the position information of the first sub-image region and positions of a plurality of image points in the first sub-image region.

In some implementations, the specific configuration of the cluster determining module 540 includes: determining the cluster center to which the target image point belongs from the pre-obtained correspondences between the image points included in the first sub-image region and the cluster centers.

In some implementations, the specific configuration of the representation determining module 550 includes: performing feature fusion on the cluster center to which the target image point belongs and the first remote sensing image to obtain the representation of the first remote sensing image.

In some implementations, the specific configuration of the representation determining module 550 includes: when there are a plurality of target image points, concatenating cluster centers to which the plurality of target image points belong, to obtain a concatenated representation; and performing feature fusion on the concatenated representation and image features of the first remote sensing image.

The above-mentioned apparatus embodiments correspond to the method embodiments. For detailed descriptions, references can be made to the descriptions of the method embodiments, and details are omitted here for simplicity. The apparatus embodiments are obtained based on the corresponding method embodiments, and have the same technical effects as the corresponding method embodiments. For detailed descriptions, references can be made to the corresponding method embodiments.

One or more embodiments of this specification further provide a computer-readable storage medium. The computer-readable storage medium stores a computer program. When the computer program is executed on a computer, the computer is enabled to perform the method in any of FIG. 1 to FIG. 3.

One or more embodiments of this specification further provide a computing device, including a storage and a processor. The storage stores executable code, and the processor executes the executable code, to implement the method in any of FIG. 1 to FIG. 3.

The embodiments of this specification are described in a progressive way. For same or similar parts of the embodiments, mutual references can be made to the embodiments. Each embodiment focuses on a difference from other embodiments. Particularly, the storage medium and computing device embodiments are basically similar to the method embodiments, and therefore are described briefly. For related parts, references can be made to the descriptions in the method embodiments.

A person skilled in the art should be aware that in the above-mentioned one or more examples, functions described in some embodiments of this application can be implemented by hardware, software, firmware, or any combination thereof. When these functions are implemented by software, they can be stored in a computer-readable medium or transmitted as one or more instructions or code on the computer-readable medium.

The above-mentioned specific implementations further describe in detail the objectives, technical solutions, and beneficial effects of the embodiments of this application. It should be understood that, the above-mentioned descriptions are merely specific implementations of the embodiments of this application, and are not intended to limit the protection scope of this application. Any modification, equivalent replacement, or improvement made based on the technical solutions in this application shall fall within the protection scope of this application.

1. A method for remote sensing images, comprising:
dividing a global remote sensing image into sub-image regions in a predetermined manner;
for each sub-image region of the sub-image regions:
determining image point features of image points in the sub-image region based on a feature extraction model;
identifying image points in the sub-image region based on the image point features; and
determining a cluster center for the identified image points; and
adjusting a remote sensing model based on cluster centers determined for each of the sub-image regions.

2. The method according to claim 1, wherein the dividing a global remote sensing image into sub-image regions in a predetermined manner comprises:
dividing the global remote sensing image based on a predetermined remote sensing tile-level size; or
dividing the global remote sensing image based on geographical regions comprised in the global remote sensing image.

3. The method according to claim 1, wherein the determining image point features of image points in the sub-image region comprises:
obtaining prior knowledge of the sub-image region; and
determining the image point features of the image points in the sub-image region based on the prior knowledge.

4. The method according to claim 3, wherein the determining image point features of image points in the sub-image region comprises:
dividing the sub-image region into patches; and
for each patch, inputting the prior knowledge and the patch into the feature extraction model to obtain image point features of a plurality of image points in the patch.

5. The method according to claim 1, wherein a size of the image point is a predetermined pixel-level size.

6. The method of claim 1, wherein the method further comprising:
obtaining a first remote sensing image to be processed and first position information of the first remote sensing image;
determining, based on the first position information, a first sub-image region of the sub-image regions having position information that matches the first position information;
determining a target image point corresponding to the first remote sensing image from first image points comprised in the first sub-image region;
determining, based on predetermined correspondences between the first image points and the cluster centers, a cluster center corresponding to the target image point; and
determining a representation of the first remote sensing image based on the cluster center.

7. The method according to claim 6, wherein the determining a representation of the first remote sensing image comprises:
performing feature fusion on the cluster center and the first remote sensing image to obtain the representation of the first remote sensing image.

8. An apparatus for remote sensing images, comprising:
at least one processor; and
one or more memories coupled to the at least one processor and storing programming instructions for execution by the at least one processor to perform operations comprising:
dividing a global remote sensing image into sub-image regions in a predetermined manner;
for each sub-image region of the sub-image regions:
determining image point features of image points in the sub-image region based on a feature extraction model;
identifying image points in the sub-image region based on the image point features; and
determining a cluster center for the identified image points; and
adjusting a remote sensing model based on cluster centers determined for each of the sub-image regions.

9. The apparatus according to claim 8, wherein the dividing a global remote sensing image into sub-image regions in a predetermined manner comprises:
dividing the global remote sensing image based on a predetermined remote sensing tile-level size; or
dividing the global remote sensing image based on geographical regions comprised in the global remote sensing image.

10. The apparatus according to claim 8, wherein the determining image point features of image points in the sub-image region comprises:
obtaining prior knowledge of the sub-image region; and
determining the image point features of the image points in the sub-image region based on the prior knowledge.

11. The apparatus according to claim 10, wherein the determining image point features of image points in the sub-image region comprises:
dividing the sub-image region into patches; and
for each patch, inputting the prior knowledge and the patch into the feature extraction model to obtain image point features of a plurality of image points in the patch.

12. The apparatus according to claim 8, wherein a size of the image point is a predetermined pixel-level size.

13. The apparatus of claim 8, wherein the operations further comprising:
obtaining a first remote sensing image to be processed and first position information of the first remote sensing image;
determining, based on the first position information, a first sub-image region of the sub-image regions having position information that matches the first position information;
determining a target image point corresponding to the first remote sensing image from first image points comprised in the first sub-image region;
determining, based on predetermined correspondences between the first image points and the cluster centers, a cluster center corresponding to the target image point; and
determining a representation of the first remote sensing image based on the cluster center.

14. The apparatus according to claim 13, wherein the determining a representation of the first remote sensing image comprises:
performing feature fusion on the cluster center and the first remote sensing image to obtain the representation of the first remote sensing image.

15. A non-transitory computer-readable storage medium storing programming instructions for execution by at least one processor to perform operations comprising:
dividing a global remote sensing image into sub-image regions in a predetermined manner;
for each sub-image region of the sub-image regions:
determining image point features of image points in the sub-image region based on a feature extraction model;
identifying image points in the sub-image region based on the image point features; and
determining a cluster center for the identified image points; and
adjusting a remote sensing model based on cluster centers determined for each of the sub-image regions.

16. The non-transitory computer-readable storage medium according to claim 15, wherein the dividing a global remote sensing image into sub-image regions in a predetermined manner comprises:
dividing the global remote sensing image based on a predetermined remote sensing tile-level size; or
dividing the global remote sensing image based on geographical regions comprised in the global remote sensing image.

17. The non-transitory computer-readable storage medium according to claim 15, wherein the determining image point features of image points in the sub-image region comprises:
obtaining prior knowledge of the sub-image region; and
determining the image point features of the image points in the sub-image region based on the prior knowledge.

18. The non-transitory computer-readable storage medium according to claim 17, wherein the determining image point features of image points in the sub-image region comprises:
dividing the sub-image region into patches; and
for each patch, inputting the prior knowledge and the patch into the feature extraction model to obtain image point features of a plurality of image points in the patch.

19. The non-transitory computer-readable storage medium according to claim 8, wherein a size of the image point is a predetermined pixel-level size.

20. The non-transitory computer-readable storage medium of claim 15, wherein the operations further comprising:
obtaining a first remote sensing image to be processed and first position information of the first remote sensing image;
determining, based on the first position information, a first sub-image region of the sub-image regions having position information that matches the first position information;
determining a target image point corresponding to the first remote sensing image from first image points comprised in the first sub-image region;
determining, based on predetermined correspondences between the first image points and the cluster centers, a cluster center corresponding to the target image point; and
determining a representation of the first remote sensing image based on the cluster center.
